(19) United States
(12) Patent Application Publication
(10) Pub. No.: US 2013/0300325 A1
(43) Pub. Date: Nov. 14, 2013

(54) CONTROL METHOD AND CONTROL APPARATUS FOR BRUSHLESS MOTOR

(71) Applicants: Hiroshi AIZAWA, Chiyoda-ku (JP); Hiroaki MORIMOTO, Minato-ku (JP)

(72) Inventors: Hiroshi AIZAWA, Chiyoda-ku (JP); Hiroaki MORIMOTO, Minato-ku (JP)

(73) Assignee: MITSUBISHI ELECTRIC CORPORATION, Tokyo (JP)

(21) Appl. No.: 13/613,371

(22) Filed: Sep. 13, 2012

(30) Foreign Application Priority Data
May 8, 2012 (JP) 2012-106404

(51) Int. Cl. H02P 6/20

(52) U.S. Cl. 318/400.11

(57) ABSTRACT

Energization to armature windings of a brushless motor in a driven state is interrupted when an energization pattern of the energization shifts to a specific energization pattern determined in advance among a plurality of energization patterns to stop the brushless motor. Also, the brushless motor that has been stopped is started by energizing the armature windings of the brushless motor in the specific energization pattern.

### BACKGROUND OF THE INVENTION

1. Field of the Invention

The present invention relates to a control method and a control apparatus to control a brushless motor, and more particularly, to a control method and a control apparatus of a brushless motor by which a brushless motor in a driven state is stopped or a brushless motor in a stopped state is started again.

2. Related Art

A control apparatus of a brushless motor in the related art is disclosed, for example, in Patent Document 1. According to this control apparatus, an inductive voltage generated in an armature winding of a stator by rotations of a rotor is detected and a position detection signal corresponding to a position of the rotor is obtained by comparing the detected inductive voltage with a reference voltage. Energization to the armature winding is controlled by an energization timing signal generated on the basis of the position detection signal and a pulse width modulation signal.

With the control apparatus of a brushless motor in the related art disclosed in Patent Document 1, it is possible to drive the brushless motor effectively while the rotor is rotating. However, while the brushless motor is stopped, no inductive voltage is generated in the armature winding. Accordingly, the control apparatus cannot detect a positional relation between the stator and the rotor when the brushless motor is started. Hence, the control apparatus generates a rotating field in the stator by switching an energization timing signal at regular time intervals so that phases of currents passed through respective phases of the armature winding are displaced by 120 electrical degrees with respect to each other and thereby forcedly rotates the rotor. Because an inductive voltage is generated in the armature winding after the brushless motor is started in this manner, the control apparatus performs a commutation operation on switching devices of a drive circuit on the basis of the inductive voltage and then shifts to a normal control operation.
Patent Document 1: Japanese Patent No. 3308680

The control apparatus of a brushless motor in the related art disclosed in Patent Document 1, however, has problems as follows. That is, when an energization pattern for the armature winding of the stator fails to have a predetermined relation with respect to the position of the rotor when forced driving is started, the brushless motor rotates in a backward direction, the brushless motor loses steps, a drive current is increased, and vibrations during the driving become considerable.

### SUMMARY OF THE INVENTION

The invention is devised to solve the problems of the control apparatus of a brushless motor in the related art as discussed above and has an object to provide a control method and a control apparatus of a brushless motor causing no inconveniences, such as the brushless motor rotates in a backward direction at startup.

A control method of a brushless motor according to a first aspect of the invention is a control method of a brushless motor for controlling a brushless motor including a stator having an armature winding and a rotor having a rotor magnetic pole, and includes: stopping the brushless motor in a driven state by interrupting energization to the armature winding of the brushless motor when an energization pattern of the energization shifts to a specific energization pattern determined in advance among a plurality of energization patterns; and starting the brushless motor that has been stopped by energizing the armature winding of the brushless motor in the specific energization pattern.

Also, a control method of a brushless motor according to a second aspect of the invention is a control method of a brushless motor for controlling a brushless motor including a stator having an armature winding and a rotor having a rotor magnetic pole, and includes: stopping the brushless motor in a driven state by interrupting energization to the armature winding and storing an energization pattern when the energization is interrupted; and starting the brushless motor that has been stopped by energizing the armature winding of the brushless motor in the stored energization pattern.

Further, a control apparatus of a brushless motor according to a third aspect of the invention is a control apparatus of a brushless motor that controls the brushless motor using a control method of a brushless motor configured in such a manner that the brushless motor in a driven state is stopped by interrupting energization to the armature winding of the brushless motor when an energization pattern of the energization shifts to a specific energization pattern determined in advance among a plurality of energization patterns, and that the brushless motor that has been stopped is started by energizing the armature winding of the brushless motor in the specific energization pattern.

Furthermore, a control apparatus of a brushless motor according to a fourth aspect of the invention is a control apparatus of a brushless motor that controls the brushless motor using a control method of a brushless motor configured in such a manner that the brushless motor in a driven state is stopped by interrupting energization to the armature winding and an energization pattern when the energization is interrupted is stored, and that the brushless motor that has been stopped is started by energizing the armature winding of the brushless motor in the stored energization pattern.

The control method of a brushless motor according to the first aspect of the invention is configured in such a manner that the brushless motor in a driven state is stopped by interrupting energization to the armature winding of the brushless motor when an energization pattern of the energization shifts to a specific energization pattern determined in advance among a plurality of energization patterns, and that the brushless motor that has been stopped is started by energizing the armature winding of the brushless motor in the specific energization pattern. It thus becomes possible to start the brushless motor in a reliable manner without having to estimate or detect a position of the rotor when the rotor is stopped.

Also, the control method of a brushless motor according to the second aspect of the invention is configured in such a manner that the brushless motor in a driven state is stopped by interrupting energization to the armature winding and an energization pattern when the energization is interrupted is stored, and that the brushless motor that has been stopped is started by energizing the armature winding of the brushless motor in the stored energization pattern. It thus becomes possible to start the brushless motor in a reliable manner without having to estimate or detect a position of the rotor when the rotor is stopped.

Further, the control apparatuses of a brushless motor according to the third and fourth aspects of the invention are configured in such a manner that the control apparatuses control the brushless motor using the control methods of a brushless motor according to the first and second aspects of the invention, respectively. It thus becomes possible to start the brushless motor using a simple configuration in a reliable manner without having to estimate or detect a position of the rotor when the rotor is stopped.

The foregoing and other objects features, aspects, and advantages of the present invention will become more apparent from the following detailed description of the present invention when taken conjunction with the accompanying drawings.

### BRIEF DESCRIPTION OF THE DRAWINGS

FIG. 1 is a view showing a configuration of a control apparatus of a brushless motor according to a first embodiment of the invention;

FIG. 2 is a view used to describe energization patterns in accordance with a control method and the control apparatus of a brushless motor according to the first embodiment of the invention;

FIG. 3 is a flowchart depicting a control logic when a brushless motor is stopped in accordance with the control method of a brushless motor according to the first embodiment of the invention;

FIG. 4A through FIG. 4C are conceptual views each showing a positional relation between a stator and a rotor when the brushless motor is started in accordance with the control method of a brushless motor according to the first embodiment of the invention;

FIG. 5A through FIG. 5D are conceptual views each showing a positional relation between a stator and a rotor when the brushless motor is started without using the control method of a brushless motor according to the first embodiment of the invention;

FIG. 6 is a flowchart depicting a control logic when a brushless motor is stopped in accordance with a control method of a brushless motor according to a second embodiment of the invention; and

FIG. 7 is a flowchart depicting a control logic when the brushless motor is started in accordance with the control method of a brushless motor according to the second embodiment of the invention.

### DESCRIPTION OF THE PREFERRED EMBODIMENTS

### First Embodiment

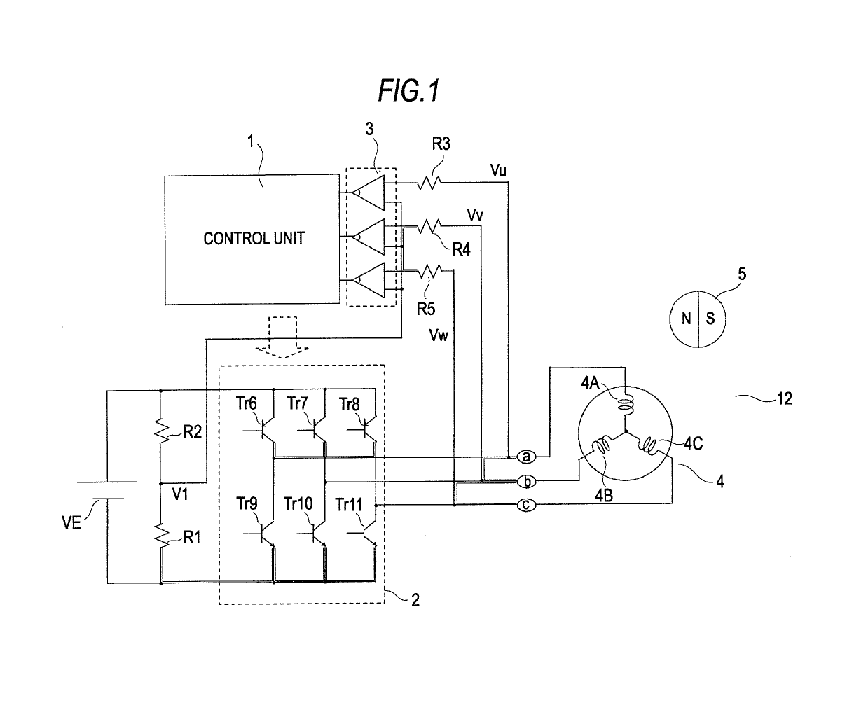

Hereinafter, a control method of a brushless motor and a control apparatus of a brushless motor using this control method according to a first embodiment of the invention will be described. The control method and the control apparatus of a brushless motor according to the first embodiment of the invention are used, for example, for a motor of a fuel pump installed to a vehicle. FIG. 1 is a view showing a configuration of the control apparatus of a brushless motor according to the first embodiment of the invention. The control apparatus is configured in such a manner so as to use the control method of a brushless motor according to the first embodiment of the invention described below. Referring to FIG. 1, a brushless motor 12 includes a stator 4 and a rotor 5. The stator 4 has armature windings 4A, 4B, and 4C of three phases: a phase U, a phase V, and a phase W, respectively. The rotor has a north rotor magnetic pole and a south rotor magnetic pole.

A drive circuit 2 is formed of a three-phase power conversion circuit as a three-phase inverter or a three-phase converter and includes a semiconductor switching device Tr6 forming a U-phase upper arm, a semiconductor switching device Tr9 forming a U-phase lower arm, a semiconductor switching device Tr7 forming a V-phase upper arm, a semiconductor switching device Tr10 forming a V-phase lower arm, a semiconductor switching device Tr8 forming a W-phase upper arm, and a semiconductor switching device Tr11 forming a W-phase lower arm. These semiconductor switching devices Tr6 through Tr11 are formed of transistors and referred to as transistors in the following description.

One ends of the upper arms of the respective phases, which serve as a DC positive-electrode terminal of the drive circuit 2, are connected to a positive-electrode terminal of a battery VE, which is a DC power supply. One ends of the lower arms of the respective phases, which serve as a DC negative-electrode terminal, are connected to a negative-electrode terminal of the DC power supply VE. Connected portions of the other ends of the upper arms of the respective phases and the other ends of the lower arms of the respective phases of the drive circuit 2 serve as AC terminals of the respective phases of the drive circuit 2 and connected to winding terminals a, b, and c of the armature windings 4A, 4B, and 4C of the respective phases of the brushless motor 12. Series-connected voltage dividing resistors R1 and R2 are connected between the DC positive-electrode terminal and the DC negative-electrode terminal of the drive circuit 2.

Three first input terminals of a comparison unit 3 are connected to the winding terminals a, b, and c of the respective phases of the brushless motor 12 via resistors R3, R4, and R5, respectively. Three second input terminals are connected collectively and connected to a series-connected point of the voltage dividing resistors R1 and R2. The comparison unit 3 compares inductive voltages Vu, Vv, and Vw induced in the armature windings 4A, 4B, and 4C of the respective phases of the brushless motor 12 and inputted to the respective first input terminals with a reference voltage V1 inputted into the respective second input terminals, and outputs comparison signals according to a comparison result.

A control unit 1 determines whether a drive condition of the brushless motor 12 is established on the basis of the comparison signals of the respective phases inputted therein from the comparison unit 3. In a case where the drive condition is established, the control unit 1 switches the transistors Tr6 through Tr11 ON and OFF according to energization patterns described below. The control unit 1 can be of a known configuration, for example, as with control apparatuses 41 and 50 described in Patent Document 1, including a latch circuit, a main control circuit, a latch timing signal generation circuit, a voltage command signal generation circuit, and a PWM signal generation circuit.

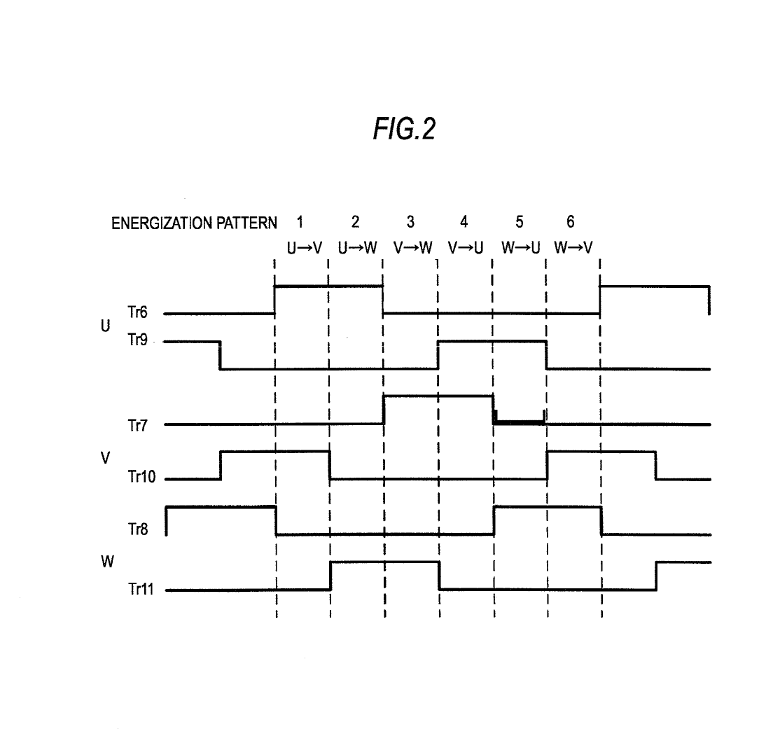

FIG. 2 is a view used to describe energization patterns in accordance with the control method and the control apparatus of a brushless motor according to the first embodiment of the invention. More specifically, FIG. 2 shows transitions with time of ON and OFF states for each of the transistor Tr6 in the U-phase upper arm and the transistor Tr9 in the U-phase lower arm, the transistor Tr7 in the V-phase upper arm and the transistor Tr10 in the V-phase lower arm, and the transistor Tr8 in the W-phase upper arm and the transistor Till in the W-phase lower arm in the drive circuit 2. In waveforms of the respective transistors Tr6 through Tr11, an ON state of each transistor is indicated by a high level and an OFF state of each transistor is indicated by a low level.

According to an energization pattern 1, the transistor Tr6 in the U-phase upper arm and the transistor Tr10 in the V-phase lower arm are switched ON and all of the other transistors are switched OFF. Hence, according to the energization pattern 1, a DC current from the positive-electrode terminal of the battery VE shown in FIG. 1 flows through a circuit starting from the transistor Tr6 in the U-phase upper arm, sequentially followed by the U-phase armature winding 4A, the V-phase armature winding 4B, and the transistor Tr10 in the V-phase lower arm, and ending at the negative-electrode terminal of the battery VE.

According to an energization pattern 2, the transistor Tr6 in the U-phase upper arm and the transistor Till in the W-phase lower arm are switched ON and all the other transistors are switched OFF. Hence, according to the energization pattern 2, a DC current from the positive-electrode terminal of the battery VE flows through a circuit starting from the transistor Tr6 in the U-phase upper arm, sequentially followed by the U-phase armature winding 4A, the W-phase armature winding 4C, and the transistor Tr11 in the W-phase lower arm, and ending at the negative-electrode terminal of the battery VE.

According to an energization pattern 3, the transistor Tr7 in the V-phase upper arm and the transistor Tr11 in the W-phase lower arm are switched ON and all of the other transistors are switched OFF. Hence, according to the energization pattern 3, a DC current from the positive-electrode terminal of the battery VE flows through a circuit starting from the transistor Tr7 in the V-phase upper arm, sequentially followed by the V-phase armature winding 4B, the W-phase armature winding 4C, and the transistor Tr11 in the W-phase lower arm, and ending at the negative-electrode terminal of the battery VE.

According to an energization pattern 4, the transistor Tr7 in the V-phase upper arm and the transistor Tr9 in the U-phase lower arm are switched ON and all of the other transistors are switched OFF. Hence, according to the energization pattern 4, a DC current from the positive-electrode terminal of the battery VE flows through a circuit starting from the transistor Tr7 in the V-phase upper arm, sequentially followed by the V-phase armature winding 4B, the U-phase armature winding 4A, and the transistor Tr9 in the U-phase lower arm, and ending at the negative-electrode terminal of the battery VE.

According to an energization pattern 5, the transistor Tr8 in the W-phase upper arm and the transistor Tr9 in the U-phase lower arm are switched ON and all of the other transistors are switched OFF. Hence, according to the energization pattern 5, a DC current from the positive-electrode terminal of the battery VE flows through a circuit starting from the transistor Tr8 in the W-phase upper arm, sequentially followed by the W-phase armature winding 4C, the U-phase armature winding 4A, and the transistor Tr9 in the U-phase lower arm, and ending at the negative-electrode terminal of the battery VE.

According to an energization pattern 6, the transistor Tr8 in the W-phase upper arm and the transistor Tr10 in the V-phase lower arm are switched ON and all of the other transistors are switched OFF. Hence, according to the energization pattern 6, a DC current from the positive-electrode terminal of the battery VE flows through a circuit starting from the transistor Tr8 in the W-phase upper arm, sequentially followed by the W-phase armature winding 4C, the V-phase armature winding 4B, and the transistor Tr10 in the V-phase lower arm, and ending at the negative-electrode terminal of the battery VE.

The control unit 1 controls the respective transistors Tr6 through Tr11 to switch ON and OFF so that the armature windings 4A, 4B, and 4C are energized in order of the energization patterns 1 through 6. Amounts of energization to the respective armature windings 4A, 4B, and 4C are determined by adjusting ON periods and OFF periods of the respective transistors Tr6 through Tr11 according to a PWM control signal from the control unit 1.

While the brushless motor 12 is driven, an armature current from the drive circuit 2 is supplied to the armature windings 4A, 4B, and 4C of the respective phases of the brushless motor 12 in order of the energization patterns 1 through 6 and a rotating field is therefore generated in the stator 4. The rotor 5 rotates in synchronization with rotations of the rotating field generated in the stator 4.

A method of stopping a brushless motor in accordance with the control method of a brushless motor according to the first embodiment of the invention will now be described. The control method of a brushless motor according to the first embodiment of the invention is to stop a brushless motor when an energization pattern to the armature windings is a specific energization pattern determined in advance.

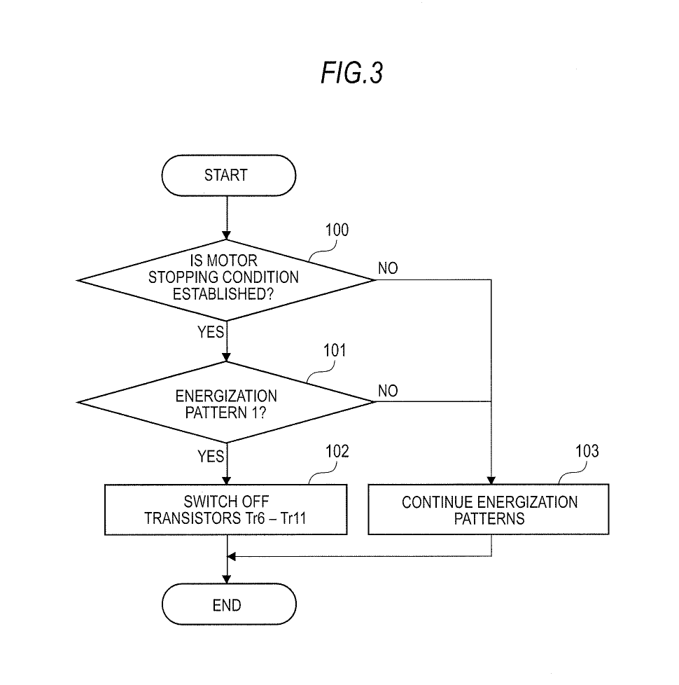

FIG. 3 is a flowchart depicting a control logic when a brushless motor is stopped in accordance with the control method of a brushless motor according to the first embodiment of the invention. The control logic depicted in the flowchart of FIG. 3 is a control logic by which the brushless motor 12 is stopped when an energization pattern to the armature windings 4A, 4B, and 4C at startup of the brushless motor 12 is the energization pattern 1 shown in FIG. 2. In short, an energization pattern when the brushless motor 12 is stopped is determined to be the energization pattern 1 in advance.

Referring to FIG. 3, in Step 100, it is determined whether a stopping condition of the brushless motor 12, for example, a condition under which there arises no problem when the brushless motor 12 is stopped, that is, a state where there arises no problem when a supply of fuel is stopped, is established. When it is found from the determination result in Step 100 that the stopping condition is not established (N), the flow proceeds to Step 103 and energization is continued according to the energization patterns in the order as specified above, so that the rotor 5 continues to rotate.

On the other hand, when it is found from the determination result in Step 100 that the stopping condition is established (Y), the flow proceeds to Step 101. In Step 101, it is confirmed whether the energization pattern to the armature windings 4A, 4B, and 4C is the energization pattern 1. When it is confirmed that the energization pattern is the energization pattern 1 (Y), the flow proceeds to Step 102 in which all the transistors Tr6 through Tr11 are switched OFF. By switching OFF all the transistors Tr6 through Tr11 in the drive circuit 2 in Step 102, the brushless motor 12 is stopped because energization to the armature windings 4A, 4B, and 4C is interrupted.

On the other hand, when it is found in Step 101 that the current energization pattern is not the energization pattern 1 (N), the flow proceeds to Step 103, so that the brushless motor 12 is continuously driven by continuing energization to the armature windings 4A, 4B, and 4C according to the energization patterns in the order specified above. In this manner, even in a case where the control unit 1 determines that the stopping condition of the brushless motor 12 is established in Step 100, when the current energization pattern is not the energization pattern 1, the control unit 1 continues the driving of the brushless motor 12 until the current energization pattern shifts to the energization pattern 1.

The control apparatus of a brushless motor according to the first embodiment of the invention is configured in such a manner so as to control a brushless motor using the control method of a brushless motor according to the first embodiment of the invention as described above. More specifically, a computation portion, such as a microprocessor provided to the control unit 1 shown in FIG. 1, is programmed to perform the control method of a brushless motor according to the first embodiment of the invention.

As has been described, the control method of a brushless motor according to the first embodiment of the invention is to stop the brushless motor 12 by switching OFF all the transistors Tr6 through Tr11 when it is confirmed that energization pattern to the armature windings 4A, 4B, and 4C of the brushless motor 12 being driven is the energization pattern 1, which is the specific energization pattern determined in advance. While the brushless motor 12 is driven, the brushless motor 12 drives a predetermined load. Hence, when a supply of an armature current is stopped as all the transistors Tr6 through Tr11 are switched OFF, the rotor 5 stops immediately with respect to the stator 4 at a position corresponding to the energization pattern 1 in which the supply is stopped. Hence, this control method is not to allow the rotor 5 to continue to rotate by inertia even when a supply of the armature current is stopped as in the absence of a load.

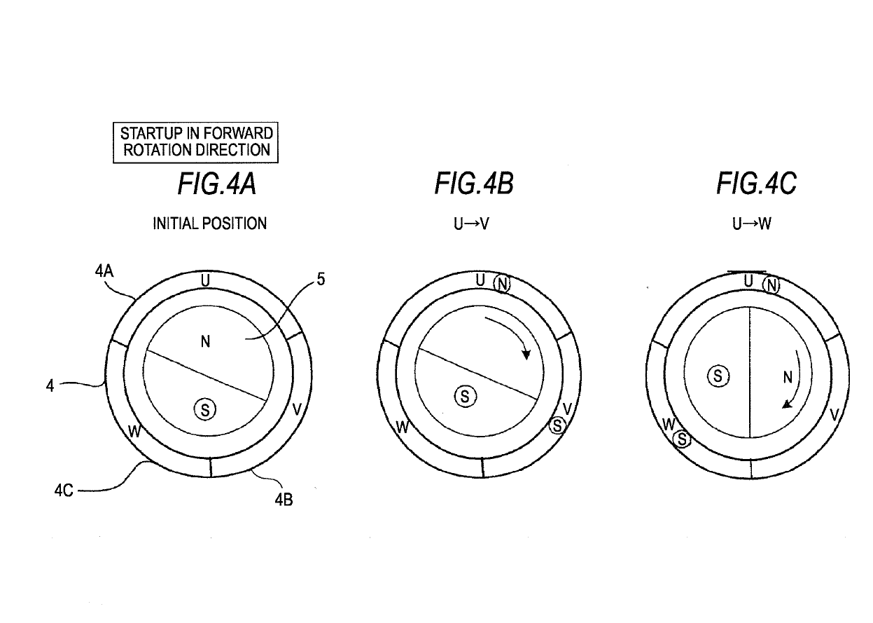

A case where a brushless motor is started in accordance with the control method of a brushless motor according to the first embodiment of the invention will now be described. FIGS. 4A through 4C are conceptual views each showing a positional relation between a stator and a rotor of a brushless motor at startup in accordance with the control method of a brushless motor according to the first embodiment of the invention. FIG. 4A shows a relation of a position of a magnetic pole of the rotor 5 with respect to the stator 4 at an initial position before startup. FIG. 4B shows a relation between a rotating field of the stator 4 and a position of the magnetic pole of the rotor 5 at startup in the energization pattern 1. FIG. 4C shows a relation between a rotating field of the stator 4 and a position of the magnetic pole of the rotor 5 when the energization pattern 1 shifts to the energization pattern 2.

As is shown in FIG. 4A, the initial position of the rotor 5 while the brushless motor 12 is stopped is at a position corresponding to the energization pattern 1 in which the brushless motor 12 is stopped as described above. More specifically, the north rotor magnetic pole of the rotor 5 opposes a region covering the U-phase armature winding 4A and the V-phase armature winding 4B of the stator 4 and the south rotor magnetic pole opposes a region covering the W-phase armature winding 4C and the V-phase armature winding 4B.

When the brushless motor 12 is started, as is shown in FIG. 4B, energization is started from the energization pattern 1 in which the brushless motor 12 is stopped as described above. In the case of the energization pattern 1, as has been described above, the transistor Tr6 in the U-phase upper arm and the transistor Tr10 in the V-phase lower arm in the drive circuit 2 shown in FIG. 1 are switched ON and all the other transistors are switched OFF. Hence, a DC current from the positive-electrode terminal of the battery VE flows through a circuit starting from the transistor Tr6 in the U-phase upper arm, sequentially followed by the U-phase armature winding 4A, the V-phase armature winding 4B, and the transistor Tr10 in the V-phase lower arm, and ending at the negative-electrode terminal of the battery VE. In this case, as is shown in FIG. 4B, the U-phase armature winding 4A generates a magnetic flux as a north pole and the V-phase armature winding 4B generates a magnetic flux as a south pole.

Hence, at startup, the north rotor magnetic pole of the rotor 5 repels the magnetic flux of the U-phase armature winding 4A and is attracted by the magnetic flux of the V-phase armature winding 4B while the south rotor magnetic pole repels the magnetic flux of the V-phase armature winding 4B and is attracted by the magnetic flux of the U-phase armature winding 4A. Consequently, as is shown in FIG. 4B, the rotor 5 is started in a forward rotation direction that is a clockwise direction. Then, the energization pattern 1 shifts to the energization pattern 2. According to the energization pattern 2, as has been described, the transistor Tr6 in the U-phase upper arm and the transistor Tr11 in the W-phase lower arm are switched ON and all the other transistors are switched OFF. Hence, a DC current from the positive-electrode terminal of the battery VE flows through a circuit starting from the transistor Tr6 in the U-phase upper arm, sequentially followed by the U-phase armature winding 4A, the W-phase armature winding 4C, and the transistor Tr11 in the W-phase lower arm, and ending at the negative-electrode terminal of the battery VE. In this case, as is shown in FIG. 4C, the U-phase armature winding 4A generates a magnetic flux as a north pole and the W-phase armature winding 4C generates a magnetic flux as a south pole.

Accordingly, the north rotor magnetic pole of the rotor 5 repels the magnetic flux of the U-phase armature winding 4A and is attracted by the magnetic flux of the W-phase armature winding 4C while the south rotor magnetic pole repels the magnetic flux of the W-phase armature winding 4C and is attracted by the magnetic flux of the U-phase armature winding 4A. The rotor 5 therefore continues to rotate in the forward rotation direction that is a clockwise direction. Thereafter, although the energization pattern shifts one by one in the order specified in FIG. 2, the rotor 5 continues to rotate in the forward direction.

In this manner, in a case where the brushless motor 12 is stopped in the specific energization pattern 1 determined in advance, the initial position of the rotor 5 is at the position indicted in FIG. 4A and the rotor 5 rotates by 60° in the forward direction by energization in the first energization pattern 1 at startup and rotates further by 60° in the forward direction by energization in the following energization pattern 2. In other words, because the initial position of the rotor 5 coincides with the position in the first conduction pattern 1 at startup, the rotor 5 is allowed to rotate in the forward direction at startup from the beginning.

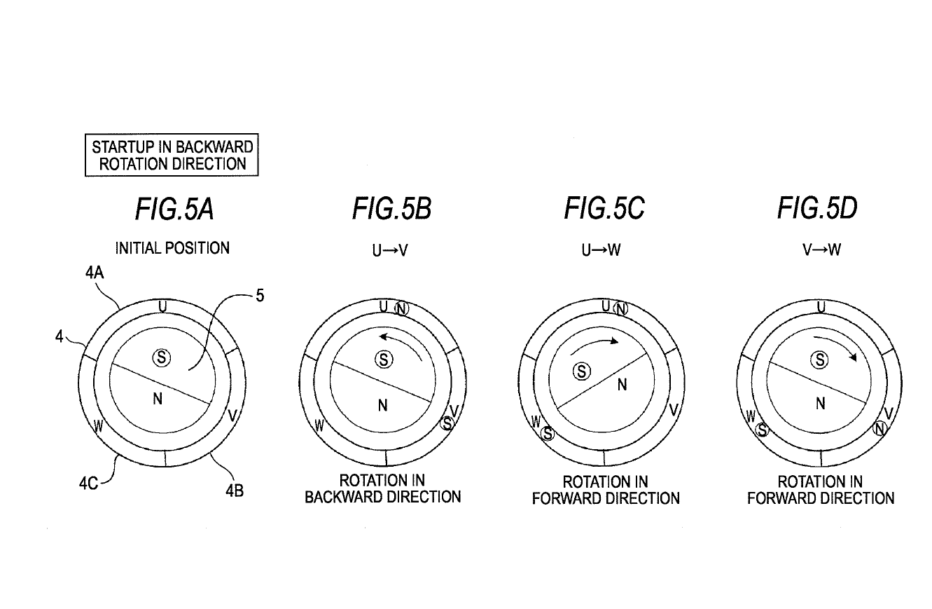

For the purpose of comparison with the control method of a brushless motor according to the first embodiment of the invention, a case where a brushless motor is started without using the control method of a brushless motor according to the first embodiment of the invention will now be described. FIGS. 5A through 5D are conceptual views each showing a positional relation between a stator and a rotor of a brushless motor at startup in a case where the control method of a brushless motor according to the first embodiment of the invention is not used.

In a case where an energization pattern when the brushless motor 12 is stopped is not determined to be a specific energization pattern in advance, it is uncertain in which energization pattern the brushless motor 12 is stopped. Hence, the initial position of the rotor 5 before startup is uncertain, too. For example, as is shown in FIG. 5A, there may be a case where the rotor 5 before startup is at the initial position at which the south rotor magnetic pole of the rotor 5 opposes a region covering the U-phase armature winding 4A and the V-phase armature winding 4B and the north rotor magnetic pole opposes a region covering the W-phase armature winding 4C and the V-phase armature winding 4B.

In this case, as is shown in FIG. 5B, when the brushless motor 12 is started in the energization pattern 1, the south rotor magnetic pole of the rotor 5 is attracted by a magnetic flux of the U-phase armature winding 4A as a north pole while the north rotor magnetic pole is attracted by a magnetic flux of the V-phase armature winding 4B as a south pole. Consequently, the rotor 5 is started to rotate in an anti-clockwise direction in the drawing, that is, in a backward direction. Subsequently, as the energization pattern 1 shifts to the energization pattern 2, as is shown in FIG. 5C, the north rotor magnetic pole of the rotor 5 is attracted by a magnetic flux of the W-phase armature winding 4C as a south pole while the south rotor magnetic pole is attracted by a magnetic flux of the U-phase armature winding 4A as a north pole. Consequently, the rotor 5 that has started rotating backward in an anti-clockwise direction reverses the rotating direction and rotates in a clockwise direction that is the forward rotation direction. In the following energization pattern 3, too, as is shown in FIG. 5D, the rotor 5 continues to rotate in the forward rotation direction. Thereafter, although the energization pattern shifts one by one in the order specified in FIG. 2, the rotor 5 continues to rotate in the forward direction.

In this manner, in a case where the energization pattern when the brushless motor 12 is stopped is not particularly determined, there may be a case as is shown in FIG. 5A where the initial position of the rotor 5 does not coincide with a position in the first energization pattern at startup. In this case, the rotor 5 rotates by 60° in the backward direction in the first energization at startup and then reverses the rotation direction to rotate by 60° in the forward direction in the second energization. Reversing the rotation direction as above is extremely disadvantageous in some cases depending on a load driven by the brushless motor 12.

As has been described, the energization patterns as shown in FIG. 2 are determined in advance while the brushless motor is normally driven. Hence, the brushless motor may possibly rotate in the backward direction at startup when the positions of the rotor and the stator do not coincide with those when the brushless motor is stopped. However, according to the control method of a brushless motor and the control apparatus of a brushless motor using this control method according to the first embodiment of the invention, because the rotor can be stopped in the specific energization pattern determined in advance, it becomes possible to stop the brushless motor in position. Consequently, because there is no risk that the rotor rotates in the backward direction when the brushless motor is started, it becomes possible to start the brushless motor in a reliable manner.

### Second Embodiment

A control method of a brushless motor according to a second embodiment of the invention will now be described. The control apparatus of a brushless motor shown in FIG. 1 is configured so as to use the control method of a brushless motor according to the second embodiment of the invention. In the control method of a brushless motor according to the second embodiment of the invention, an energization pattern when the brushless motor 12 is stopped is not particularly determined in advance. Instead, the energization pattern when the brushless motor 12 is stopped is stored in an EEPROM.

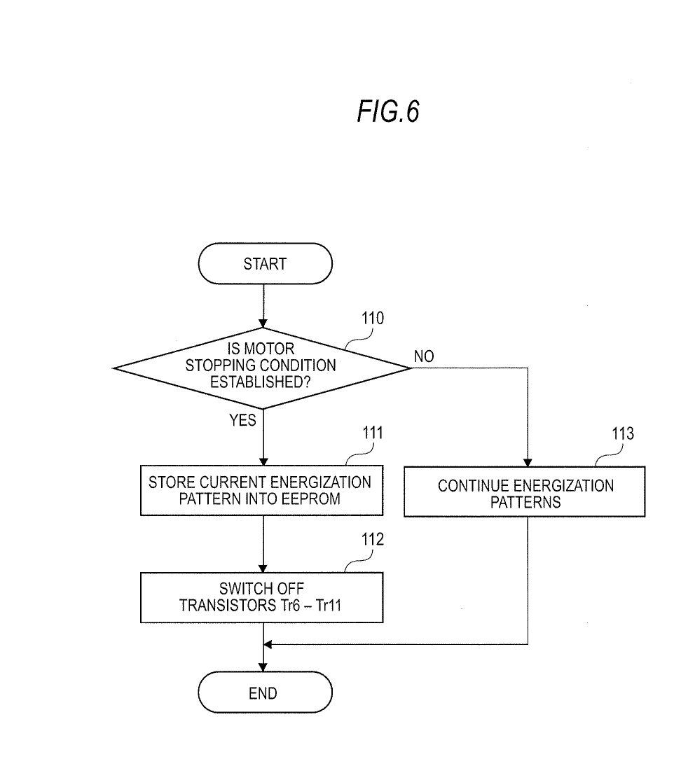

FIG. 6 is a flowchart depicting a control logic when stopping a brushless motor in accordance with the control method of a brushless motor according to the second embodiment of the invention. Referring to FIG. 6, in Step 110, it is determined whether a stopping condition of the brushless motor 12 as described above is established. When it is determined that the stopping condition is established (Y), the flow proceeds to Step 111 and the flow proceeds to Step 113 when it is determined that the stopping condition is not established (N).

In Step 111, the current energization pattern to the armature windings 4A, 4B, and 4C of the brushless motor 12 is stored in an EEPROM. Subsequently, in Step 112, energization to the armature windings 4A, 4B, and 4C is interrupted by switching OFF all the transistors Tr6 through Tr11 in the drive circuit 2 to stop the brushless motor 12. In this instance, the EEPROM stores the energization pattern when the brushless motor 12 is stopped.

On the other hand, in a case where the stopping condition of the brushless motor 12 is not established and the flow proceeds to Step 113, energization is continued in the respective energization patterns in the order specified in FIG. 2 to continuously drive the brushless motor 12.

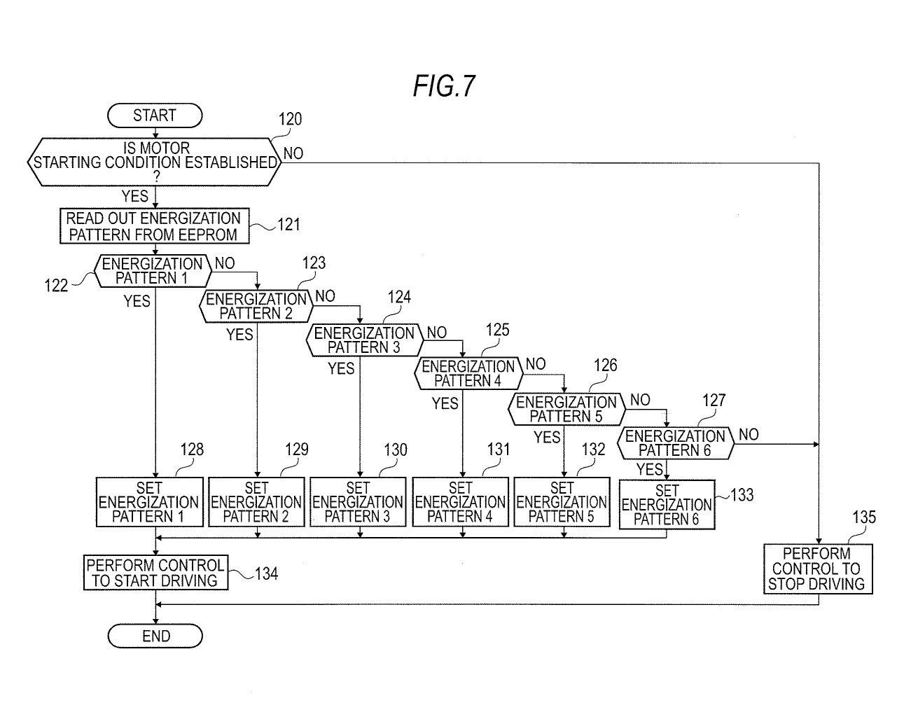

Startup of a brushless motor in accordance with the control method of a brushless motor according to the second embodiment of the invention will now be described. FIG. 7 is a flowchart depicting a control logic when a brushless motor is started in accordance with the control method of a brushless motor according to the second embodiment of the invention. Referring to FIG. 7, in Step 120, it is determined whether a starting condition of the brushless motor 12 is established. When it is determined that the starting condition is established (Y), the flow proceeds to Step 121 and the flow proceeds to Step 135 when it is determined that the startup condition is not established (N).

When the flow proceeds to Step 120 to Step 121, the energization pattern stored in the EEPROM when the brushless motor 12 is stopped is read out in Step 121. Subsequently, in Step 122, whether the read energization pattern is the energization pattern 1 is determined. Ina case where the read energization pattern is the energization pattern 1 (Y), the energization pattern 1 is set as the energization pattern at startup of the brushless motor 12 in Step 128. Subsequently, the flow proceeds to Step 134 in which control is performed to start driving of the brushless motor 12 in the energization pattern 1.

When it is determined from the determination result in Step 122 that the read energization pattern is not the energization pattern 1 (N), the flow proceeds to Step 123 in which whether the read energization pattern is the energization pattern 2 is determined. When the read energization pattern is the energization pattern 2 (Y), the energization pattern 2 is set as the energization pattern at startup of the brushless motor 12 in Step 129. Subsequently, the flow proceeds to Step 134 in which control is performed to start driving of the brushless motor 12 in the energization pattern 2.

When it is determined from the determination result in Step 123 that the read energization pattern is not the energization pattern 2 (N), the flow proceeds to Step 124 in which whether the read energization pattern is the energization pattern 3 is determined. When the read energization pattern is the energization pattern 3 (Y), the energization pattern 3 is set as the energization pattern at startup of the brushless motor 12 in Step 130. Subsequently, the flow proceeds to Step 134 in which control is performed to start driving of the brushless motor 12 in the energization pattern 3.

When it is determined from the determination result in Step 124 that the read energization pattern is not the energization pattern 3 (N), the flow proceeds to Step 125 in which whether the read energization pattern is the energization pattern 4 is determined. When the read energization pattern is the energization pattern 4 (Y), the energization pattern 4 is set as the energization pattern at startup of the brushless motor 12 in Step 131. Subsequently, the flow proceeds to Step 134 in which control is performed to start driving of the brushless motor 12 in the energization pattern 4.

When it is determined from the determination result in Step 125 that the read energization pattern is not the energization pattern 4 (N), the flow proceeds to Step 126 in which whether the read energization pattern is the energization pattern 5 is determined. When the read energization pattern is the energization pattern 5 (Y), the energization pattern 5 is set as the energization pattern at startup of the brushless motor 12 in Step 132. Subsequently, the flow proceeds to Step 134 in which control is performed to start driving of the brushless motor 12 in the energization pattern 5.

When it is determined from the determination result in Step 126 that the read energization pattern is not the energization pattern 5 (N), the flow proceeds to Step 127 in which whether the read energization pattern is the energization pattern 6 is determined. When the read energization pattern is the energization pattern 6 (Y), the energization pattern 6 is set as the energization pattern at startup of the brushless motor 12 in Step 133. Subsequently, the flow proceeds to Step 134 in which control is performed to start driving of the brushless motor 12 in the energization pattern 6.

On the other hand, when it is determined from the determination result in Step 120 that the starting condition of the brushless motor 12 is not established (N), the flow proceeds to Step 135 in which control is performed to stop driving of the brushless motor 12.

A control apparatus of a brushless motor according to the second embodiment of the invention is configured so as to control a brushless motor using the control method of a brushless motor according to the second embodiment of the invention described above. This control apparatus can be of the same configuration as the counterpart in the first embodiment above shown in FIG. 1. In this case, it should be noted, however, that a computation portion, such as a microprocessor provided to the control unit 1, is programed to perform the control method of a brushless motor according to the second embodiment of the invention.

As has been described, with the control method of a brushless motor according to the second embodiment of the invention, the energization pattern when the brushless motor is stopped is stored into the EEPROM. Hence, by reading out the stored energization pattern from the EEPROM before the brushless motor is started, it becomes possible to start the brushless motor in the energization pattern same as the one when the brushless motor is stopped. It thus becomes possible to start the brushless motor in a reliable manner without losing steps or rotating in a backward direction.

In the first embodiment and the second embodiment described above, there may be a case where the rotor rotates by inertia in the absence of an external load when the brushless motor is stopped. In order to avoid this inconvenience, by causing a three-phase short-circuit by switching ON the transistors Tr6 through Tr8 in the upper arms of the respective phases and switching OFF the transistors Tr9 through Tr11 in the lower arms in the drive circuit 2 shown in FIG. 1, it becomes possible to stop the brushless motor 12 safely and swiftly using regenerative energy. Alternatively, it is also possible to stop the brushless motor 12 safely and swiftly using regenerative energy by causing a three-phase short-circuit by switching OFF the transistors Tr6 through Tr8 in the upper arms and switching ON the transistors Tr9 through Tr11 in the lower arms.

With the control apparatus of a brushless motor shown in FIG. 1, by causing a two-phase short-circuit by switching ON the transistors in the upper arms of two out of three phases and switching OFF the transistors in the lower arms, or by switching OFF the transistors in the upper arms of two out of three phases and switching ON the transistors in the lower arms, it becomes possible to attenuate regenerative energy in comparison with a case of causing a three-phase short-circuit. Accordingly, it becomes possible to stop the brushless motor more moderately than in the case of causing a three-phase short-circuit.

Further, in a case where the brushless motor is stopped using regenerative energy by causing a three-phase short-circuit or a two-phase short-circuit as described above, regenerative energy is decreased by controlling the transistors to be switched ON by PWM so as to output a low duty. It becomes possible to stop the brushless motor moderately using this nature. Conversely, by configuring so as to output a high duty, it becomes possible to lessen a decrease of regenerative energy. Accordingly, the brushless motor stops swiftly. With the configurations as above, it becomes possible to stop the brushless motor in various manners.

In a case where the brushless motor is stopped using regenerative energy by causing a three-phase short-circuit or a two-phase short-circuit, when it is desirable to reduce a speed at a constant ratio, it is necessary to maintain regenerative energy at a constant level from a start of a speed reduction of the brushless motor until the brushless motor stops. However, because regenerative energy is proportional to a rotating speed of the brushless motor, when a fixed duty is given, regenerative energy does not remain at a constant level from the start of a speed reduction of the brushless motor until the brushless motor stops. Under these circumstances, because a rotating speed of the brushless motor is high at the start of a speed reduction, in order to maintain regenerative energy at a constant level until the brushless motor stops, it becomes necessary to start an output from a low duty. Hence, by increasing a duty as a rotating speed of the brushless motor decreases by regenerative energy, it becomes possible to maintain regenerative energy at a constant level from the start of a speed reduction until the brushless motor stops. In this manner, in a case where it is desirable to reduce a rotating speed gradually, a speed reduction of the brushless motor may be started from timing at which different energization pattern is outputted, so that the brushless motor is stopped in the desired energization pattern.

As has been described, the control method of a brushless motor of the invention is characterized as follows.

(1) The control method of a brushless motor of the invention is a control method of a brushless motor for controlling a brushless motor including a stator having an armature winding and a rotor having a rotor magnetic pole, including: stopping the brushless motor in a driven state by interrupting energization to the armature winding of the brushless motor when an energization pattern of the energization shifts to a specific energization pattern determined in advance among a plurality of energization patterns; and starting the brushless motor that has been stopped by energizing the armature winding of the brushless motor in the specific energization pattern.

(2) Also, the control method of a brushless motor of the invention is a control method of a brushless motor for controlling a brushless motor including a stator having an armature winding and a rotor having a rotor magnetic pole, including: stopping the brushless motor in a driven state by interrupting energization to the armature winding and storing an energization pattern when the energization is interrupted; and starting the brushless motor that has been stopped by energizing the armature winding of the brushless motor in the stored energization pattern.

(3) The armature winding is formed of a three-phase armature winding and the energization to the armature winding is interrupted by a drive circuit formed of a three-phase power conversion circuit, while the three-phase power conversion circuit includes upper arms of respective three phases each provided with a switching device and lower arms of respective three phases each provided with a switching device, so that the energization to the armature winding is interrupted by switching ON at least two switching devices of switching devices provided to the upper arms of the respective three phases and switching OFF all switching devices provided to the lower arms of the respective three phases.

(4) The energization to the armature winding is interrupted by a drive circuit formed of a three-phase power conversion circuit, and the three-phase power conversion circuit includes upper arms of respective three phases each provided with a switching device and lower arms of respective three phases each provided with a switching device, while the armature winding is formed of a three-phase armature winding, so that the energization to the armature winding is interrupted by switching OFF all switching devices provided to the upper arms of the respective three phases and switching ON at least two switching devices of switching devices provided to the lower arms of the respective three phases.

(5) At least the two switching devices to be switched ON are controlled by PWM.

(6) At least the two switching elements to be switched ON are controlled by varying a PWM duty.

The control apparatus of a brushless motor of the invention is characterized as follows.

(7) The control apparatus controls a brushless motor using the control method of a brushless motor in any one of (1) through (6) above.

Various modifications and alterations of this invention will be apparent to those skilled in the art without departing from the scope and spirit of this invention, and it should be understood that this is not limited to the illustrative embodiments set forth herein.

What is claimed is:

1. A control method of a brushless motor for controlling a brushless motor including a stator having an armature winding and a rotor having a rotor magnetic pole, comprising:
stopping the brushless motor in a driven state by interrupting energization to the armature winding of the brushless motor when an energization pattern of the energization shifts to a specific energization pattern determined in advance among a plurality of energization patterns; and
starting the brushless motor that has been stopped by energizing the armature winding of the brushless motor in the specific energization pattern.

2. The control method of a brushless motor according to claim 1, wherein
the armature winding is formed of a three-phase armature winding;
the energization to the armature winding is interrupted by a drive circuit formed of a three-phase power conversion circuit;
the three-phase power conversion circuit includes upper arms of respective three phases each provided with a switching device and lower arms of respective three phases each provided with a switching device; and
the energization to the armature winding is interrupted by switching ON at least two switching devices of switching devices provided to the upper arms of the respective three phases and switching OFF all switching devices provided to the lower arms of the respective three phases.

3. The control method of a brushless motor according to claim 2, wherein
at least the two switching devices to be switched ON are controlled by PWM.

4. The control method of a brushless motor according to claim 3, wherein
at least the two switching elements to be switched ON are controlled by varying a PWM duty.

5. The control method of a brushless motor according to claim 1, wherein
the armature winding is formed of a three-phase armature winding;
the energization to the armature winding is interrupted by a drive circuit formed of a three-phase power conversion circuit;
the three-phase power conversion circuit includes upper arms of respective three phases each provided with a switching device and lower arms of respective three phases each provided with a switching device; and
the energization to the armature winding is interrupted by switching OFF all switching devices provided to the upper arms of the respective three phases and switching ON at least two switching devices of switching devices provided to the lower arms of the respective three phases.

6. The control method of a brushless motor according to claim 5, wherein
at least the two switching devices to be switched ON are controlled by PWM.

7. The control method of a brushless motor according to claim 6, wherein
at least the two switching elements to be switched ON are controlled by varying a PWM duty.

8. A control method of a brushless motor for controlling a brushless motor including a stator having an armature winding and a rotor having a rotor magnetic pole, comprising:
stopping the brushless motor in a driven state by interrupting energization to the armature winding and storing an energization pattern when the energization is interrupted; and
starting the brushless motor that has been stopped by energizing the armature winding of the brushless motor in the stored energization pattern.

9. The control method of a brushless motor according to claim 8, wherein
the armature winding is formed of a three-phase armature winding;
the energization to the armature winding is interrupted by a drive circuit formed of a three-phase power conversion circuit;
the three-phase power conversion circuit includes upper arms of respective three phases each provided with a switching device and lower arms of respective three phases each provided with a switching device; and
the energization to the armature winding is interrupted by switching ON at least two switching devices of switching devices provided to the upper arms of the respective three phases and switching OFF all switching devices provided to the lower arms of the respective three phases.

10. The control method of a brushless motor according to claim 9, wherein
at least the two switching devices to be switched ON are controlled by PWM.

11. The control method of a brushless motor according to claim 10, wherein
at least the two switching elements to be switched ON are controlled by varying a PWM duty.

12. The control method of a brushless motor according to claim 8, wherein
the armature winding is formed of a three-phase armature winding;
the energization to the armature winding is interrupted by a drive circuit formed of a three-phase power conversion circuit;
the three-phase power conversion circuit includes upper arms of respective three phases each provided with a switching device and lower arms of respective three phases each provided with a switching device; and
the energization to the armature winding is interrupted by switching OFF all switching devices provided to the upper arms of the respective three phases and switching ON at least two switching devices of switching devices provided to the lower arms of the respective three phases.

13. The control method of a brushless motor according to claim 12, wherein
at least the two switching devices to be switched ON are controlled by PWM.

14. The control method of a brushless motor according to claim 13, wherein
at least the two switching elements to be switched ON are controlled by varying a PWM duty.

15. A control apparatus of a brushless motor that controls a brushless motor using the control method of a brushless motor set forth in claim 1.

16. A control apparatus of a brushless motor that controls a brushless motor using the control method of a brushless motor set forth in claim 8.
